(19) United States
(12) Patent Application Publication
(10) Pub. No.: US 2016/0168493 A1
(43) Pub. Date: Jun. 16, 2016

(54) SYSTEM AND METHOD FOR GASIFICATION

(71) Applicant: General Electric Company, Schenectady, NY (US)

(72) Inventor: John Saunders Stevenson, Anaheim, CA (US)

(21) Appl. No.: 14/572,426

(22) Filed: Dec. 16, 2014

(51) Int. Cl. C10J 3/82; C10J 3/02; C01B 3/36; C10J 3/22

(52) U.S. Cl. CPC C10J 3/82; C10J 3/22; C10J 3/02; C01B 3/36; C10J 2200/09; C10J 2300/0956; C10J 2300/0959; C10J 2300/1846; C01B 2203/0255

(57) ABSTRACT

A system includes a gasifier configured to gasify a feed to generate syngas. The gasifier comprises a first axis. The system also includes a first gasification reaction zone disposed in the gasifier. The first gasification reaction zone is defined at least partially by a first wall substantially perpendicular to the first axis. The system also includes a first feed injector coupled to the gasifier. The first feed injector is configured to inject the feed into the first gasification reaction zone beneath the first wall in a first direction relative to the first axis.

### BACKGROUND

The subject matter disclosed herein relates to gasifiers and, more particularly, systems and methods for the design of reaction zones for gasifiers.

Gasifiers convert carbonaceous materials into a mixture of carbon monoxide and hydrogen, referred to as synthesis gas or syngas. For example, an integrated gasification combined cycle (IGCC) power plant includes one or more gasifiers that react a feedstock at a high temperature with oxygen and temperature moderator, such as steam or water, to produce syngas. Unfortunately, the resulting syngas from gasification may include less desirable components, such as molten slag and/or fine ash, in gasifiers. Slag and/or ash in the syngas may affect the operation of equipment downstream of the gasifier.

### BRIEF DESCRIPTION

Certain embodiments commensurate in scope with the present disclosure are summarized below. These embodiments are not intended to limit the scope of the claims, but rather these embodiments are intended only to provide a brief summary of possible forms of the present disclosure. Indeed, embodiments of the present disclosure may encompass a variety of forms that may be similar to or different from the embodiments set forth below.

In a first embodiment, a system includes a gasifier configured to gasify a feed to generate syngas. The gasifier comprises a first axis. The system also includes a first gasification reaction zone disposed in the gasifier. The first gasification reaction zone is defined at least partially by a first wall substantially perpendicular to the first axis. The system also includes a first feed injector coupled to the gasifier. The first feed injector is configured to inject the feed into the first gasification reaction zone beneath the first wall in a first direction relative to the first axis.

In a second embodiment, a method includes gasifying a feed in a gasification reaction zone disposed in a gasifier to generate syngas. The gasifier comprises a first axis. The method also includes injecting the feed into the gasification reaction zone using a feed injector coupled to the gasifier, flowing the syngas through the gasification reaction zone in a first direction substantially perpendicular to the first axis using a first wall, and discharging the syngas from the gasification reaction zone in a second direction substantially parallel to the first axis.

In a third embodiment, a system includes a gasifier configured to gasify a feed to generate syngas. The gasifier comprises a first axis. The system also includes a gasification reaction zone disposed in the gasifier. The gasification reaction zone is defined by a first conduit with a second axis substantially perpendicular to the first axis. The system also includes a first outlet disposed in the first conduit. The first outlet is substantially centered about the first axis and is configured to direct the syngas in a first direction substantially parallel to the first axis. The system also includes a first feed injector coupled to a first end of the first conduit. The first feed injector is configured to inject the feed into the gasification reaction zone in a second direction substantially perpendicular to the first axis.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an embodiment of a gasifier with a reaction fixture, in accordance with the present disclosure;

FIG. 2 is a cross-sectional view of an embodiment of a gasifier with a reaction fixture, in accordance with the present disclosure;

FIG. 3 is another cross-sectional view of the embodiment of the gasifier of FIG. 2;

FIG. 4 is a cross-sectional view of an embodiment of a reaction fixture, in accordance with the present disclosure;

FIG. 5 is a cross-sectional view of an embodiment of a reaction fixture, in accordance with the present disclosure;

FIG. 6 is a cross-sectional view of an embodiment of a reaction fixture, in accordance with the present disclosure;

FIG. 7 is a cross-sectional view of an embodiment of a gasifier having a reaction fixture, in accordance with the present disclosure;

FIG. 8 is a cross-sectional view of an embodiment of a gasifier having a reaction fixture, in accordance with the present disclosure;

FIG. 9 is a cross-sectional view of an embodiment of a reaction fixture that includes at least two feed injectors, in accordance with the present disclosure;

FIG. 10 is a top view of an embodiment of a reaction fixture that includes three feed injectors, in accordance with the present disclosure;

FIG. 11 is a cross-sectional view of an embodiment of a gasifier having a reaction fixture that includes at least two feed injectors, in accordance with the present disclosure;

FIG. 12 is a cross-sectional view of an embodiment of a gasifier having a reaction fixture that includes at least two feed injectors, in accordance with the present disclosure;

FIG. 13 is a cross-sectional view of an embodiment of a gasifier having a reaction fixture that includes at least two feed injectors, in accordance with the present disclosure; and

FIG. 14 is a cross-section view of an embodiment of a gasifier having a reaction fixture that includes at least two feed injectors, in accordance with the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

The present disclosure provides a reaction fixture disposed within a gasifier to promote carbon conversion of fuel feed and separation of syngas and slag produced in the gasifier. The reaction fixture, in accordance with the present disclosure, may include at least a first wall, which may be substantially horizontally (e.g., perpendicular to a longitudinal axis of the gasifier) disposed within the gasifier. A first gasification reaction zone includes an interior region of the gasifier that is generally beneath the first wall. One or more feed injectors may be fluidly coupled to the first gasification reaction zone and configured to inject feed into the first gasification reaction zone in a substantially horizontal direction. The injected feed undergoes partial oxidization reactions in the first gasification reaction zone to produce syngas and slag and fines (e.g., unconverted or partially converted feed and fine ash). Because the first wall provides additional surface for the slag and fines, including unconverted or partially converted carbon, to contact or impact before exiting the first gasification reaction zone, the reaction area and the effective reaction residence time of the feed increases. As such, the reaction fixture (e.g., the first wall) increases the carbon conversion of the feed.

Because the first gasification reaction zone is generally beneath the first wall, the produced syngas, the slag, and the fines may exit the first gasification zone in a substantially downward direction. As the syngas, the slag, and the fines exit the reaction zone outlet, at least a portion of the syngas, together with a portion of the fines, travels substantially upwardly within the gasifier, and the slag, together with other portions of the syngas and the fines, travels substantially downwardly within the gasifier. The separation of the fines from the slag is at least partially effected due to differences in characteristics of the fines and the slag, such as size distribution and density. As such, the reaction fixture may promote the separation of the syngas from the slag and the separation of the fines from the slag within the gasifier.

In accordance with the present disclosure, the reaction fixture may include other structural components besides the first wall. In some embodiments, the reaction fixture may include the first wall and a second wall, both of which may be substantially horizontally disposed within the gasifier with the second wall disposed downwardly with respect to the first wall. Accordingly, the first gasification reaction zone includes an interior region of the gasifier that is generally disposed between or at least partially enclosed by the first and the second walls. One or more feed injectors may be fluidly coupled to the first gasification reaction zone and configured to inject feed into the first gasification reaction zone. The second wall may include an opening or outlet (e.g., a reaction zone outlet) for directing the produced syngas, along with the slag and the fines, to exit the first gasification zone in a substantially downward direction. Both of the first and the second walls may provide additional surfaces for the slag and fines, including unconverted or partially converted carbon, to contact or impact, thereby increasing the carbon conversion of the feed. In addition, as a portion of the syngas (along with a portion of the fines) may travel substantially upwardly exiting the reaction zone outlet, and as other portions of the syngas (along with the slag and other portions of the fines) may travel substantially downwardly exiting the reaction zone outlet, the reaction fixture may promote the separation of the syngas from the slag and the separation of the fines from the slag within the gasifier.

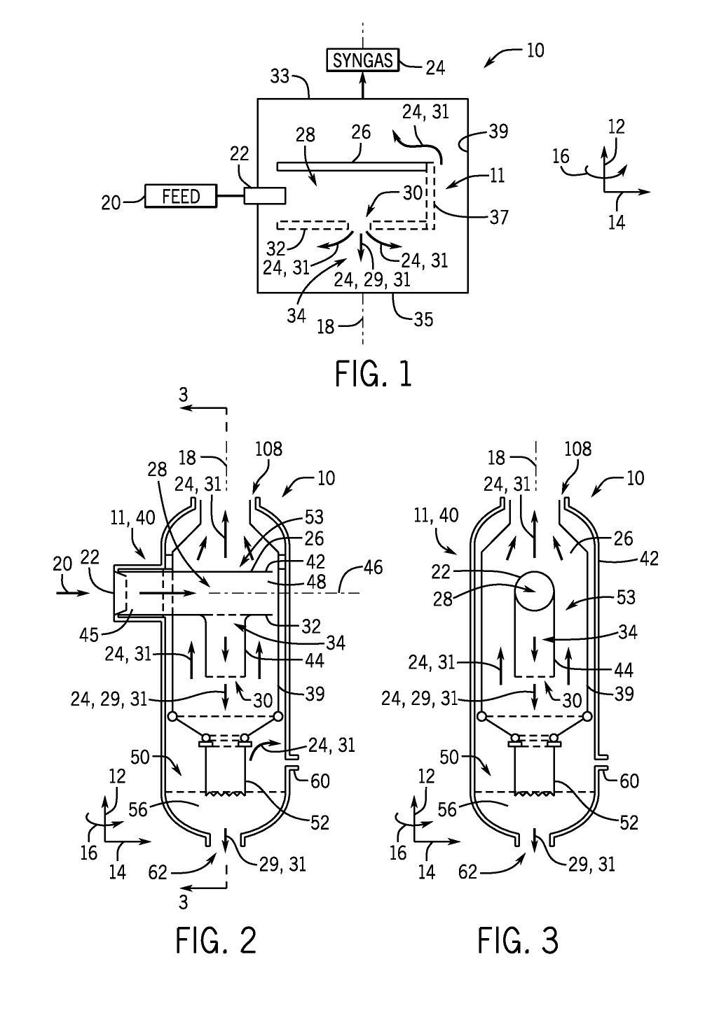

With the foregoing in mind, FIG. 1 illustrates an embodiment of a gasifier 10 with a reaction fixture 11, in accordance with the present disclosure. The disclosed embodiments may be described with respect to an axial axis or direction 12, a radial axis or direction 14, and a circumferential axis or direction 16. In addition, the gasifier 10 may have a first axis 18 that is generally parallel to the axial axis 12. In the illustrated embodiment, the reaction fixture 11 includes a feed injector 22 and a first wall 26. The feed injector 22 injects feed 20 into the gasifier 10. The feed 20 may include any suitable fuel, such as coal, petroleum coke, biomass, wood-based materials, agricultural wastes, tars, asphalt, naphtha, residuum, natural gas, fuel gas, or carbon containing materials, or any combination thereof.

As illustrated, the feed injector 22 directs the feed 20 to a first gasification reaction zone 28. The first gasification reaction zone 28 may be an area within the gasifier 10, generally underneath and proximate to the first wall 26. As shown in FIG. 1, the first wall 26 may be substantially perpendicular (e.g., about 90°±10°) to the first axis 18. Therefore, the first wall 26 directs the feed 20 in the first gasification reaction zone 28 in a generally radial direction 14 that is substantially perpendicular to the first axis 18. The first wall 26 may be generally planar or curved (e.g., downwardly concave).

Within the first gasification reaction zone 28, the feed 20 may be heated to undergo various processes, including partial oxidation reactions. As a result of partial oxidation reactions, a syngas 24 (e.g., carbon monoxide and hydrogen) is produced. In addition, non-gasifiable ash material, unconverted fuel, and/or incompletely converted fuel from the feed 20 may be produced as byproducts of the processes. These byproducts may exist as larger particles of molten slag (e.g., non-gasifiable ash material), generally referred to as slag 29, and smaller particles (e.g., unconverted fuel or partially converted fuel, and fine ash), generally referred to as fines 31.

The syngas 24, the slag 29, and the fines 31 may travel within the gasifier 10 in different directions. As illustrated, a portion of the syngas 24, along with a portion of the fines 31, after exiting the first gasification reaction zone 28, may travel in a generally upward direction parallel to the first axis 18 to exit the gasifier 10 (e.g., at or near a top section 33 of the gasifier 10). Other portions of the syngas 24 and the fines 31, along with the slag 29, after exiting the first gasification reaction zone 28, may travel in a generally downward direction parallel to the first axis 18 to exit the gasifier 10 (e.g., at or near a bottom section 35 of the gasifier 10). As discussed in greater detail below, in certain embodiments, additional gasification reaction zones (e.g., a second gasification reaction zone 34) may be disposed within the gasifier 10 to enable additional partial oxidation of the feed 20 and/or to enable increased carbon conversion of the feed 20 in the gasifier 10.

In accordance with the present disclosure, the first wall 26 may be used to provide additional surface for the slag 29 and the fines 31, including unconverted or partially converted carbon, to contact or impact before exiting the first gasification reaction zone 28, thereby increasing the carbon conversion of the feed 20. In other words, portions of the fines 31 (e.g., unconverted or partially converted portions) that come into contact with the first wall 26 may be further converted into the syngas 24. The syngas 24 and fines 31 (or at least portions thereof) may travel substantially upwardly along the first axis 18 upon exiting the first gasification reaction zone 28. The slag 29 may travel substantially downwardly along the first axis 18 upon exiting the first gasification reaction zone 28, thereby separating from the syngas 24 and the fines 31.

In accordance with the present disclosure, the reaction fixture 11 may include other structural components (e.g., walls, shrouds, casings) in addition to the first wall 26 for providing additional surfaces for the slag 29 and the fines 31, including unconverted or partially converted carbon, to contact or impact before exiting the first gasification reaction zone 28, thereby increasing the carbon conversion of the feed 20. As an example, the reaction fixture 11 may include a second wall 32 disposed substantially perpendicular (e.g., about 90°±10°) to the first axis 18 and below the first wall 26. As such, the first gasification reaction zone 28 may be an area within the gasifier 10, generally defined (e.g., enclosed or partially enclosed) by the first wall 26 and the second wall 32. In some embodiments, the first wall 26 and the second wall 32 may be separate from each other. For example, the first wall 26 and the second wall 32 are two separate plates generally parallel to one another. In other embodiments, the first wall 26 and the second wall 32 may be integrated together. For example, the first wall and the second wall 32 may be portions of a side wall of a conduit.

In the embodiments with the second wall 32, a reaction zone outlet 30 (e.g., an opening, a conduit, or a flow path) may be disposed on the second wall 32 (e.g., about the middle section of the second wall 32). The reaction zone outlet 30 is configured to direct the syngas 24, the slag 29, and the fines 31 to exit from the first gasification reaction zone 28 in a substantially downward direction parallel to the first axis 18. In certain embodiments, the second wall 32 is sloped toward the reaction zone outlet 30 to promote flowing of the syngas 24, the slag 29, and the fines 31 toward the reaction zone outlet 30. For example, the second wall 32 may be in a substantially V-shape (e.g., a frustoconical shape) with the reaction zone outlet 30 positioned about the vertex of the V-shaped second wall 32. Similarly as discussed above, as the slag 29 exiting the reaction zone outlet 30 travels substantially downwardly along the first axis 18 and the syngas 24 and fines 31 (or at least portions thereof) exiting the reaction zone outlet 30 travels substantially upwardly along the first axis 18, separation of the slag 29 from the syngas 24 and separation of the slag 29 from the fines 31 may be increased.

In addition to the second wall 32, or as an alternative, the reaction fixture 11 may include a third wall 37 disposed generally opposite to the feed injector 22. The third wall 37 is configured to completely or partially seal the first gasification reaction zone 28 at the opposite end of the feed injector 22. As such, the third wall 37 may facilitate directing the syngas 24, the slag 29, and the fines 31 to exit the first gasification reaction zone 28 substantially downwardly along the first axis 18. In certain embodiments, one or both of first wall 32 and the second wall 32 may abut an interior surface 39 (e.g., wall, casing, or shroud) of the gasifier 10 to have a similar configuration to the embodiments with the third wall 37, thereby facilitating directing the syngas 24, the slag 29, and the fines 31 to exit the first gasification reaction zone 28 substantially downwardly along the first axis 18.

The first wall 26, the second wall 32, and the third wall 37 of the reaction fixture 11 may be manufactured from any material suitable for the operating conditions of the gasifier 10, including any suitable refractory material. In some embodiments, the first wall 26, the second wall 32, or the third wall 37, or any combination thereof, may include an active cooling system to improve the integrity or temperature capability of the one or more walls. The active cooling system may be one or more cooling conduits, within which a coolant (e.g., water, steam, nitrogen, argon, carbon dioxide, organic solvent, or heat stable salts) may flow to transfer heat for utilization elsewhere, or rejection to the atmosphere (e.g., via cooling water or air cooling system) separate from or integrated with the gasifier 10.

FIGS. 2 and 3 illustrate an embodiment of the gasifier 10 having the reaction fixture 11 (e.g., a first reaction fixture 40), in accordance with the present disclosure. FIGS. 2 and 3 are cross-sectional views of the embodiment of the gasifier 10 and the first reaction fixture 40, with FIG. 3 taken along line 3-3 of FIG. 2. As illustrated, the first reaction fixture 40 includes a first conduit 42 and a second conduit 44, both of which may have substantially cylindrical shape. The first conduit 42 has a longitudinal axis that is substantially perpendicular to the first axis 18, and the second conduit 44 has a longitudinal axis that is substantially parallel to the first axis 18. In the illustrated embodiment, each of the first conduit 42 and the second conduit 44 has a substantially circular cross section. However, it should be noted that each of the first conduit 42 and the second conduit 44 may have any other suitable shapes with the cross section (perpendicular to their respective longitudinal axis) being, for example, square, rectangle, triangle, or oval. Also, it should be noted that the internal volume of the second conduit 44 may be larger than, equal to, or less than the internal volume of the first conduit 42.

As illustrated, the feed injector 22 is fluidly coupled to the first conduit 42 about a first end 45 of the first conduit 42 such that the feed 20 is directed from the feed injector 22 into the first conduit 42. A second end 48 of the first conduit 42 is opposite to the first end 45, and the second end 48 may be open to the interior of the gasifier 10, or closed. In the illustrated embodiment, the second end 48 is open to the interior of the gasifier 10 and may allow for the differential thermal expansion of the first conduit 42 (e.g., the first wall 26 and the second wall 32) within the gasifier 10 so as to avoid the development of excessive stresses in gasifier 10 or the first reaction fixture 40. In some embodiments, the second end 48 of the first conduit 42 is partially or substantially sealed, for example, by the interior wall 39 or the third wall 37, such that the produced syngas 24 and slag 29 may impact the interior wall 39 or the third wall 37 and return in a substantially opposite direction with respect to the direction of feed injection before exiting the first gasification reaction zone 28. The first gasification reaction zone 28 may be referred to as the area in the gasifier 10 encompassed by the first conduit 42. The first wall 26 and the second wall 32 may be generally referred to the top half wall and the bottom half wall (with respect to an axis 46) of the first conduit 42. The second conduit 44 is fluidly coupled to the first conduit 42 (e.g., about the middle portion of the first conduit 42) and opens to the interior of the gasifier 10 substantially downwardly via the reaction zone outlet 30. The area encompassed by the second conduit 44 may be referred to as the second gasification reaction zone 34 as the feed 20 (e.g., portions of the fines 31 from the first gasification reaction zone 28) may undergo additional gasification reaction in this area. That is, the amount of the unconverted fuel in the fines 31 may decrease from the first gasification reaction zone 28 to the second gasification reaction zone 34.

As noted above, at least a portion (e.g., a first portion) of the syngas 24 and at least a portion (e.g., a first portion) of the fines 31 may travel in a generally upward direction after exiting the reaction zone outlet 30 to exit the gasifier 10 near the top section 33 (e.g., via a top port 108) of the gasifier 10. As the first portions of the syngas 24 and the fines 31 travel upwardly, passing around the first reaction fixture 40, the unconverted or partially converted fuel of the first portion of fines 31 may undergo further gasification reaction. As such, the interior area of the gasifier 10 that generally around the first reaction fixture 40 may be referred to as a third gasification reaction zone 53. The amount of the unconverted fuel in the fines 31 may further decrease from the second gasification reaction zone 34 to the third gasification reaction zone 53. After exiting the gasifier 10 near the top section 33, the first portions of the syngas 24 and fines 31 may be used to generate high pressure steam or be used as reactants in a second stage gasifier. As such, the top port 108 of the gasifier 10 may be coupled to one or more other components of a gasification plant (e.g. an IGCC power plant), including a syngas cooler, a partial quencher, a reactor, a scrubber, an acid gas removal (AGR) unit, a shift reactor, or a low temperature gas cooling (LTGC) train, and/or a heat recovery unit. The slag 29, after exiting the reaction zone outlet 30, may travel in a generally downward direction parallel to the first axis 18. In some embodiments, another portion (e.g., a second portion) of the syngas 24 and another portion (e.g., a second portion) the fines 31, along with the slag 29, may travel in the generally downward direction parallel to the first axis 18. The gasifier 10 may include a quenching region 50 disposed downwardly (e.g., along the first axis 18) with respect to the first reaction fixture 40. The quenching region 50 may enable the cooling and additional separation of the slag 29 and the fines 31 from the syngas 24 (e.g., the second portion of the syngas 24).

As illustrated, the quenching region 50 of the gasifier 10 may include a dip tube 52 extending to a bath 56 having a liquid coolant (e.g., water). Although any suitable liquid (e.g., non-reactive liquid) for quenching the syngas 16 may be utilized. In some embodiments, a lower end of the dip tube 52 extends into the liquid coolant to facilitate flow of the second portion of the syngas 24 into the liquid coolant. The second portion of the syngas 24 and the second portion of the fines 31, along with the slag 29, may be cooled through contact with the liquid coolant in the bath 56. The cooled second portion of the syngas 24 (and any fines 31 and slag 29 not captured by the liquid coolant) may pass out of the liquid coolant in the radial 14 and axial 12 directions, and then may exit the gasifier 10 via a syngas outlet 60 proximate to the quenching region 50. The remainder of the second portion of the fines 31 and the slag 29 may be directed as a suspension of particulates in the liquid coolant toward a bottom outlet (or port) 62 to exit the gasifier 10 about the bottom section 35 of the gasifier 10. In some embodiments, two or more bottom outlets 62 are used, and the fines 31 and the slag 29 captured in the liquid coolant may be further segregated based on the configuration and conditions within the bath 56 and the bottom outlets 62 (e.g., the relative position of and flow rates of liquid coolant through the bottom outlets 62, the temperature, specific gravity and viscosity of the liquid coolant, and the sizes, shapes and densities of the captured fines 31 and slag 29). In some embodiments, as an alternative to the quenching region 50, a syngas cooler, a partial quench, or a reactor may be disposed downwardly (e.g., along the first axis 18) with respect to the first reaction fixture 40. The gasifier 10 may be further coupled (e.g., via the syngas outlet 60) to various other components of the gasification plant, including a scrubber, an acid gas removal (AGR) unit, a shift reactor, and/or a low temperature gas cooling (LTGC) train.

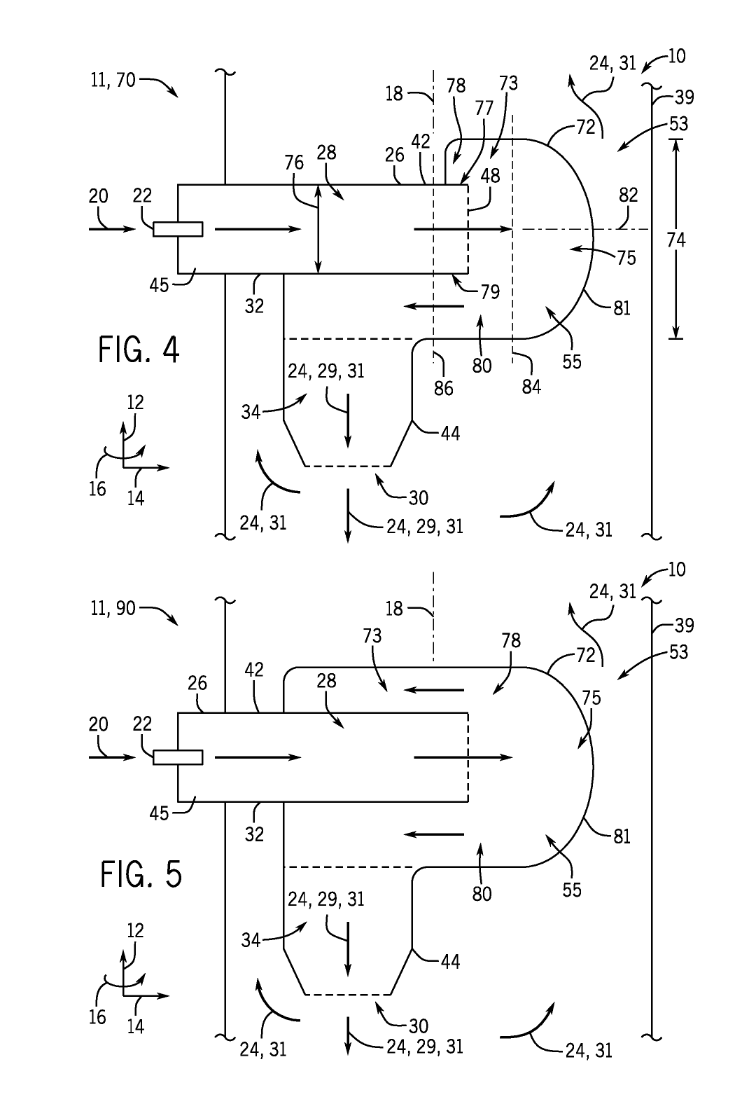

FIG. 4 illustrate another embodiment of the reaction fixture 11 (e.g., a second reaction fixture 70), in accordance with the present disclosure. The second reaction fixture 70 includes the first gasification reaction zone 28, the second gasification reaction zone 34, the third gasification reaction zone 53 (e.g., around the second reaction fixture 70), and a fourth gasification reaction zone 55. The second reaction fixture 70, as illustrated in FIG. 4, includes the same first conduit 42 as the first reaction fixture 40, as illustrated in FIG. 2. The second end 48 of the first conduit 42 in the second reaction fixture 70 is fluidly coupled to a third conduit 72. The third conduit 72 is further fluidly coupled to the second conduit 44 that opens to the interior of the gasifier 10 via the reaction zone outlet 30.

The third conduit 72 may be a partial cylinder that provides asymmetric flows of the syngas 24, the fines 31 and the slag 29 exiting the first gasification reaction zone 28. For example, the third conduit 72 and the first conduit 42 are generally in a coaxial or concentric arrangement. A diameter 74 of the third conduit 72 may be greater than a diameter 76 of the first conduit 42. The third conduit 72 at least partially encompasses a first axial portion 77 of the first conduit 42. The third conduit 72 may include an asymmetric annular portion 73 and an end portion 75 (e.g., dome-shaped). An upper portion 78 of the annular portion 73 may be sealed proximate to the second end 48 of the first conduit 42. A lower portion 80 of the annular portion 73 may encompass at least a second axial portion 79 of the first conduit 42. For example, a cross section along a line 84 is substantially circular, and a cross section along a line 86 is substantially a semicircle. The fourth gasification reaction zone 55 may be defined as the area within the third conduit 72 that is about the end portion 75 of the third conduit 72. As such, the syngas 24, the fines 31, and the slag 29 produced in the first gasification reaction zone 28 may travel to the fourth gasification reaction zone 55 substantially along the radial axis 14, impact a side wall 81 of the end portion 75 (e.g., opposite to the injector 22), and return in a substantially opposite radial direction 14 in the lower portion 80 of the annular portion 73. The returned syngas 24, the fines 31, and the slag 29 may then travel to the second gasification reaction zone 34 in the second conduit 44, and exit into the interior of the gasifier 10 via the reaction zone outlet 30.

The fourth gasification reaction zone 55, as illustrated in FIG. 4, may enable additional partial oxidation of the feed 20. For example, unreacted or partially reacted feed 20 (e.g., the fines 31 exiting the first gasification reaction zone 28) may undergo further partial oxidation reactions within the fourth gasification reaction zone 55 to produce additional syngas 24. Besides the first and second walls 26 and 32, side walls of the third conduit 72 encompassing the second gasification reaction zone 34, such as the side wall 81, may provide additional surfaces for the fines 31 and slag 29, including unconverted or partially converted carbon, to contact before exiting through the reaction zone outlet 30. Thus, the additional surface area of the second gasification reaction zone 34 and the fourth gasification reaction zone 55 may increase the carbon conversion of the feed 20 in the gasifier 10. The amount of the unconverted fuel in the fines 31 may decrease from the first gasification reaction zone 28, through the fourth gasification reaction zone 55 and the second gasification reaction zone 34, to the third gasification reaction zone 53. Although in the illustrated embodiment, the third conduit 72 is a partial cylinder, it should be noted that similar to the first conduit 42 and the second conduit 44, the third conduit 72 may have any suitable shape. For example, the cross section of the third conduit 72 along the line 84 may be square, rectangle, triangle, or oval.

FIG. 5 illustrates another embodiment of the reaction fixture 11 (e.g., a third reaction fixture 90), in accordance with the present disclosure. The third reaction fixture 90 also includes the first gasification reaction zone 28 (e.g., defined generally by the first conduit 42), the second gasification reaction zone 34 (e.g., defined generally by the second conduit 44), the third gasification reaction zone 53 (e.g., around the third reaction fixture 90), and the fourth gasification reaction zone 55 (e.g., defined generally by the third conduit 72). The third reaction fixture 90, as illustrated in FIG. 5, is similar to the second reaction fixture 70, as illustrated in FIG. 4, except that the third conduit 72 enables symmetry in the flows of the syngas 24, the fines 31, and the slag 29 from the first gasification reaction zone 28.

As illustrated, the third conduit 72 surrounds at least a portion of the first conduit 42 with both of the upper portion 78 and the lower portion 80 of the annular portion 73 providing passages for the returned (e.g., after impacting the side wall 81 of the end portion 75) syngas 24, fines 31, and slag 29 exiting the first gasification reaction zone 28. As such, the syngas 24, the fines 31, and the slag 29 produced in the first gasification reaction zone 28 travel to the fourth gasification reaction zone 55 in the radial direction 14, impacts the side wall 81 opposite to the injector 22, and returns in a substantially opposite radial direction 14 in both of the upper portion 78 and the lower portion 80 of the annular portion 73 of the third conduit 72. The returned syngas 24, fines 31, and slag 29 may then flow from the fourth gasification reaction zone 55 to the second conduit 44 (e.g., the second gasification reaction zone 34), then exit into the interior of the gasifier 10 via the reaction zone outlet 30.

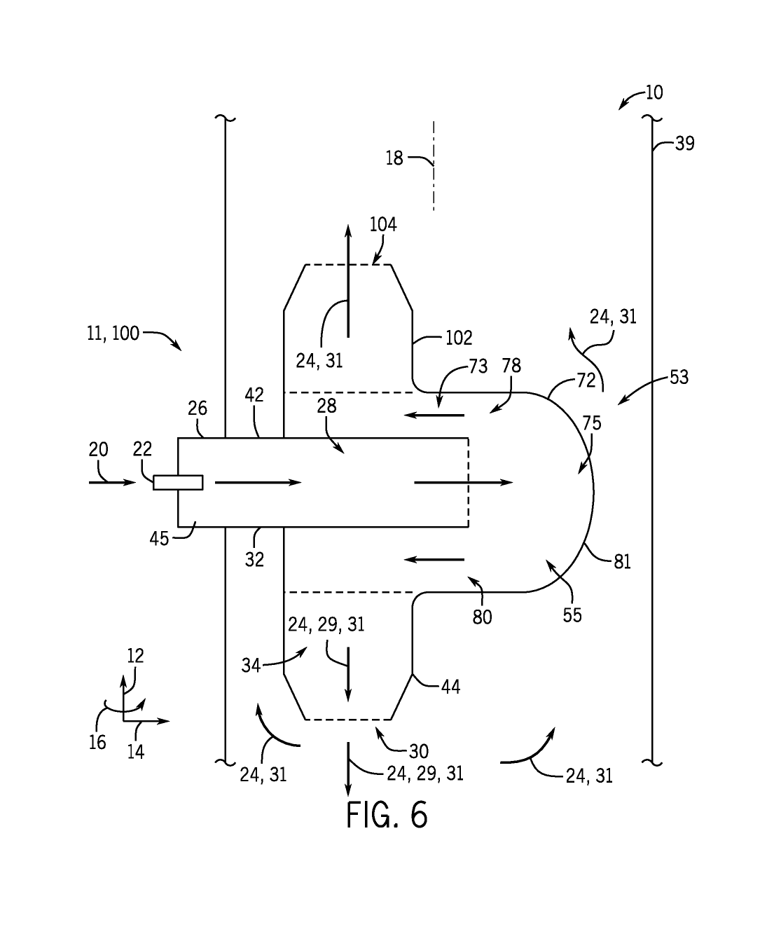

FIG. 6 illustrates another embodiment of the reaction fixture 11 (e.g., a fourth reaction fixture 100), in accordance with the present disclosure. The fourth reaction fixture 100 also includes the first gasification reaction zone 28 (e.g., defined generally by the first conduit 42), the second gasification reaction zone 34 (e.g., defined generally by the second conduit 44), the third gasification reaction zone 53 (e.g., around the fourth reaction fixture 100), and the fourth gasification reaction zone 55 (e.g., defined generally by the third conduit 72). The fourth reaction fixture 100, as illustrated in FIG. 6, is similar to the third reaction fixture 90, as illustrated in FIG. 5, except that the third conduit 72 is fluidly coupled to a fourth conduit 102 that opens to the interior of the gasifier 10 via a second reaction zone outlet 104 axially above the first conduit 42.

As illustrated, the fourth conduit 102 is fluidly coupled to the upper portion 78 of the annular portion 73 of the third conduit 72, and the second conduit 44 is fluidly coupled to the lower portion 80 of the annular portion 73 of the third conduit 72. As such, the syngas 24, the fines 31, and the slag 29 produced in the first gasification reaction zone 28 travels to the fourth gasification reaction zone 55 in the radial direction 14, impacts the side wall 81 opposite to the injector 22, and returns in a substantially opposite radial direction 14 in both of the upper portion 78 and the lower portion 80 of the annular portion 73 of the third conduit 72. A first portion of the returned syngas 24, fines 31 and slag 29 may flow from the fourth gasification reaction zone 55 to the second conduit 44 (e.g., the second gasification reaction zone 34), and exit into the interior of the gasifier 10 via the reaction zone outlet 30 axially below the first conduit 42. A second portion of the returned syngas 24, fines 31 and slag 29 may flow from the fourth gasification reaction zone 55 to the fourth conduit 102, and exit into the interior of the gasifier 10 via the second reaction zone outlet 104 substantially upwardly along the first axis 18.

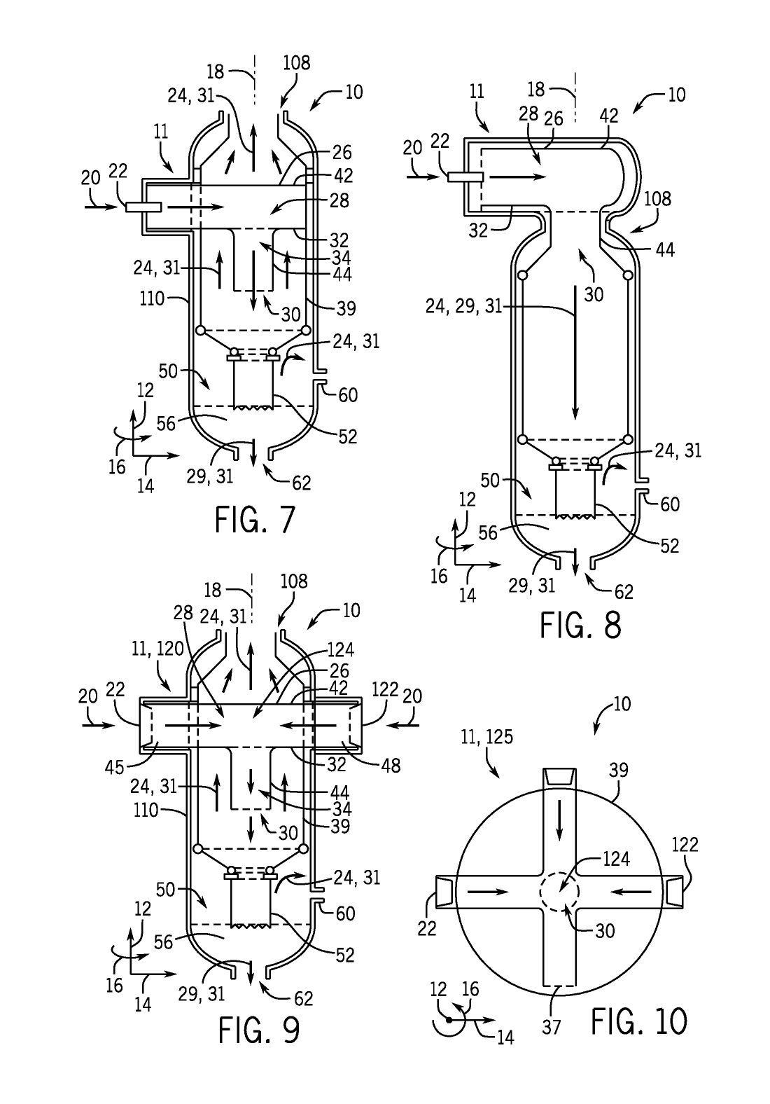

FIGS. 7 and 8 are cross-sectional views of embodiments of the gasifier 10, illustrating two modes of disposition of the reaction fixture 11 (e.g., one of the reaction fixtures 40, 70, 90, 100) into the gasifier 10, respectively. FIG. 7 illustrates the reaction fixture 11 disposed between the top port 108 and the quenching region 50 of the gasifier 10. FIG. 8 illustrates the reaction fixture 11 disposed onto the top port 108 of the gasifier 10.

More specifically, as illustrated in FIG. 7, the reaction fixture 11 (e.g., one of the reaction fixtures 40, 70, 90, 100 of FIGS. 2, 4, 5, 6, respectively) is disposed between the top port 108 and the quenching region 50 of the gasifier 10. The reaction fixture 11 includes the first conduit 42 positioned substantially radially (e.g., perpendicular to the first axis 18), and the second conduit 44 positioned substantially parallel to the first axis 18. The feed injector 22 is coupled to a side wall 110 of the gasifier 10 such that the feed 20 may be injected via the feed injector 22 into the gasifier 10 (e.g., the first gasification reaction zone 28) from one side (e.g., parallel to the radial axis 14) of the gasifier 10. The syngas 24, the fines 31, and the slag 29 exit the first gasification reaction zone 28 to the interior of the gasifier 10 via the reaction zone outlet 30 through the second gasification reaction zone 34 in the second conduit 44. At least portions of the syngas 24 and the fines 31 (e.g., the first portions described above with respect to FIGS. 2 and 3) travel substantially upwardly and exit the gasifier 10 via the top port 108, where the syngas 24 and the fines 31 may be used, for example, to generate high pressure steam or as reactants in a second stage gasifier. Other portions of the syngas 24 and the fines 31 (e.g., the second portions described above with respect to FIGS. 2 and 3) travels substantially downwardly, along with the slag 29, to the quenching region 50. As discussed above, the quenching region 50 may be configured to cool and further separate the syngas 24 and the fines 31 (e.g., the second portions) from the slag 29, and to direct the separated syngas 24 and a reduced amount of the fines 31 to exit the gasifier 10 via the syngas outlet 60. The separated slag 29 and the remaining fines 31 may exit the gasifier 10 via the bottom outlet 62 of the gasifier 10.

As illustrated in FIG. 8, the reaction fixture 11 (e.g., one of the reaction fixtures 40, 70, 90 of FIGS. 2, 4, 5, respectively) is disposed onto the top port 108 of the gasifier 10. The reaction fixture 11 includes the first conduit 42 positioned substantially radially (e.g., perpendicular to the first axis 18), and the second conduit 44 positioned substantially parallel to the first axis 18 and fluidly coupled to top port 108 of the gasifier 10. The feed injector 22 is configured to inject the feed 20 into the first conduit 42 (e.g., the first gasification reaction zone 28) from one end of the first conduit 42. The syngas 24, the fines 31, and the slag 29 exit the first gasification reaction zone 28 via the reaction zone outlet 30 to the interior of the gasifier 10. The syngas 24, the fines 31, and the slag 29 flow toward the quenching region 50. The quenching region 50 may be configured to cool and effect the further separation of the second portion of syngas 24 from the second portion of the fines 31, and the slag 29, and to direct the separated syngas 24 and a reduced amount of the fines 31 to exit the gasifier 10 via the syngas outlet 60. The separated slag 29 and the remaining fines 31 may exit the gasifier 10 via the bottom outlet 62 of the gasifier 10.

As discussed above, one feed injector (e.g., the feed injector 22) is coupled to the reaction fixture 11 (e.g., to the first end 45 of the first conduit 42). In accordance with the present disclosure, more than one (e.g., 2, 3, 4, 5, 6, 7, 8, 9, 10, or more) feed injectors may be coupled to the reaction fixture 11. For example, FIG. 9 is a cross-sectional view of an embodiment of the gasifier 10 having the reaction fixture 11 (e.g., a fifth reaction fixture 120) coupled to two feed injectors 22, 122, in accordance with the present disclosure. As illustrated, the first conduit 42 is positioned substantially radially (e.g., perpendicular to the first axis 18) and includes two ends 45, 48. The first end 45 is fluidly coupled to the feed injector 22, and the second end 48 is fluidly coupled to the feed injector 122. As illustrated, the feed injectors 22 and 122 are in substantially opposing radial directions such that the feed streams 20 injected by the feed injectors 22 and 122 may travel in substantially opposite directions along the first conduit 42, both toward a middle region 124 of the first conduit 42. The first gasification reaction zone 28 may be referred to as the region within the first conduit between the two ends 45, 48. The two fuel streams 20 injected by the feed injectors 22, 122 may mix in the first gasification reaction zone 28, thereby increasing the carbon conversion of the feed 20. In addition, the fines 31 and slag 29 of each feed stream 20 within the first gasification reaction zone 28 may also impact and/or mix with the other feed stream 20, thereby increasing the carbon conversion of the feed 20 in the gasifier 10.

The second conduit 44 is fluidly coupled to the first conduit 42. For example, the second conduit 44 is coupled to the middle region 124 of the first conduit 42. The second conduit 44 opens substantially downwardly to the interior of the gasifier 10 via the reaction zone outlet 30. Similarly as discussed above, the first portions of the produced syngas 24 and fines 31 travel substantially upwardly to exit the gasifier 10 (e.g., via the top port 108), and the second portions of the produced syngas 24 and fines 31, along with the produced slag 29 travel substantially downwardly toward the quenching region 50 for further separation (e.g., the separation of the syngas 24 from the slag 29, the separation of the fines from the slag 29). Similarly as discussed above, each of the first conduit 42 and the second conduit 44 may have a substantially circular cross section. As may be appreciated, however, each of the first conduit 42 and the second conduit 44 may have any other suitable shapes with the cross section being, for example, square, rectangle, triangle, or oval.

Although one pair of the feed injectors (e.g., the feed injectors 22 and 122) is illustrated in FIG. 9, in some embodiments, multiple pairs of opposing feed injectors may be included in the gasifier 10. For example, the reaction fixture 11 may include more than one (e.g., 2, 3, 4, 5, 6, 7, 8, 9, 10, or more) radial conduit, similar to the illustrated first conduit 42. Each of the multiple radial conduits may include a pair of the feed injectors at the two ends of the respective radial conduits, and feed flows may intersect one another at a common middle region (e.g., the middle region 124 of the first conduit 42). The common middle region may be further fluidly coupled to the second conduit 44 to direct the produced syngas 24 and the slag 29 downwardly to exit to the interior of the gasifier 10 via the reaction zone outlet 30. In addition, in other embodiments, the fifth reaction fixture 120 as illustrated in FIG. 9 may be combined with any one or more of the reaction fixtures 40, 70, 90, and 100 of FIGS. 2, 4, 5, and 6, respectively. For example, the fifth reaction fixture 120 may be combined with the first reaction fixture 40, such that the first conduit 42 of the fifth reaction fixture 120 is positioned substantially perpendicular to the first conduit 42 of the first reaction fixture 40 on the plane defined by the radial axis 14 and the circumferential axis 16, as illustrated in FIG. 10. FIG. 10 is a top view of the gasifier 10 having the reaction fixture 11 (e.g., a sixth reaction fixture 125) that combines the fifth reaction fixture 120 with the first reaction fixture 40. The first conduit 42 of the fifth reaction fixture 120 intersects the first conduit 42 of the first reaction fixture 40 at a common region about the middle region 124 of the first conduit 42 of the fifth reaction fixture 120. The common region may be further fluidly coupled to the second conduit 44 having the reaction zone outlet 30. As such, three streams of the feed 20 may be injected into and mixed within the combined reaction fixture. The produced syngas 24, fines 31, and slag 29 may exit the reaction zone into the interior of the gasifier 10 via the reaction zone outlet 30. It should be noted that one or more of the reaction fixtures 40, 70, 90 and 100 may employ multiple radial conduits similarly disposed as those described relating to FIG. 9.

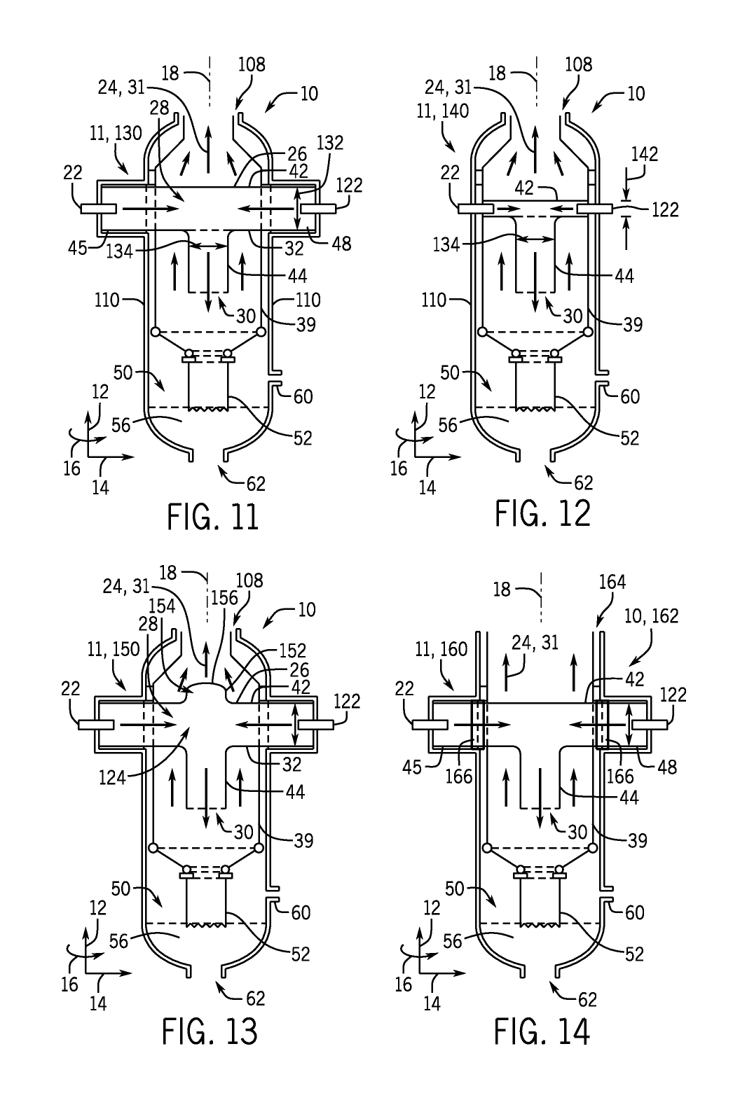

FIGS. 11-14 are cross-sectional views of the gasifier 10 having different embodiments of the reaction fixture 11 that includes two feed injectors. More specifically, FIG. 11 illustrates the reaction fixture 11 (e.g., a seventh reaction fixture 130) positioned between the top port 108 and the quenching region 50 of the gasifier 10, with the ends 45, 48 of the first conduit 42 extending out of the side wall 110 of the gasifier 10. FIG. 12 illustrates the reaction fixture 11 (e.g., an eighth reaction fixture 140) positioned between the top port 108 and the quenching region 50 of the gasifier 10, with the first conduit 42 substantially included within the interior of the gasifier 10. The feed injectors 22, 122 extend into the gasifier 10. FIG. 13 illustrates the reaction fixture 11 (e.g., a ninth reaction fixture 150) positioned between the top port 108 and the quenching region 50 of the gasifier 10, with a capped portion 152 (e.g., dome-shaped) coupled to the first conduit 42. FIG. 14 illustrates the reaction fixture 11 (e.g., a tenth reaction fixture 160) coupled to the gasifier 10 (e.g., an open top gasifier 162) positioned between a top 164 and the quenching region 50 of the gasifier 162, with impacting walls 166 disposed about the ends 45, 48 of the first conduit 42.

As illustrated in FIG. 11, the seventh reaction fixture 130 includes the first conduit 24 that extends out of the side wall 110 of the gasifier 10 about the two ends 45, 48. The feed injectors 22 and 122 are fluidly coupled to the two ends 45 and 48, respectively, and are configured to inject the feed 20 into the first gasification reaction zone 28 in opposite radial directions. The embodiment of the reaction fixture 11 as illustrated in FIG. 11 (e.g., the seventh reaction fixture 130) may also be referred to as having an extended radial (e.g., horizontal) chamber. The eighth reaction fixture 140, as illustrated in FIG. 12, is similar to the seventh reaction fixture 130, as illustrated in FIG. 11, except that the first conduit 42 of the eighth reaction fixture 140 does not extend out of the side wall 110 of the gasifier 10. In addition, a diameter 132 of the first conduit 42 of the seventh reaction fixture 130 is close to or approximately the same as a diameter 134 of the second conduit 44 of the seventh reaction fixture 130, as illustrated in FIG. 11, whereas a diameter 142 of the first conduit 42 of the eighth reaction fixture 140 is smaller than the diameter 134 of the second conduit 44 of the eighth reaction fixture 140, as illustrated in FIG. 12. The embodiment of the reaction fixture 11 as illustrated in FIG. 12 (e.g., the eighth reaction fixture 140) may also be referred to as having a minimized horizontal chamber, which is structurally more compact relative to the seventh reaction fixture 130.

The ninth reaction fixture 150, as illustrated in FIG. 13, is also similar to the seventh reaction fixture 130, as illustrated in FIG. 11, except that the ninth reaction fixture 150 includes an additional conduit (e.g., the capped portion 152) that is coupled to the first conduit 42 (e.g., the first wall 26 of the first conduit 42). The capped portion 152 is positioned approximately on an opposite side of the first conduit 42 with respect to the second conduit 44 and the reaction zone outlet 30. In some embodiments, the capped portion 152 may be positioned in other directions (e.g., substantially perpendicular to the second conduit 44 and substantially on the plane defined by the radial axis 14 and the circumferential axis 16) with respect to the second conduit 44. In certain embodiments, the capped portion 152 may have an enlarged portion disposed approximately midway along the first conduit 42. This capped portion 152 may provide an expansion area that increases a residence time and/or reduces the effects of flame impingement in the first gasification reaction zone 28. It should be noted that the capped portion 152 may be in any suitable shape, with a cross section of, for example, circular, square, rectangle, triangle, or oval.

The capped portion 152 may provide a raised region 154 (e.g., a mixing chamber) above the first conduit 42. The raised region 154 may allow for the expansion of the feed 20 as the feed 20 heats up and reacts towards the middle region 124 of the first conduit 42. The raised region 154 may also increase the surface area of the first gasification reaction zone 28 relative to the seventh reaction fixture 130. As such, the raised region 154 may provide additional surface area and volume for mixing and/or expansion of the fuel streams injected by the feed injectors 22, 122. Additionally, or in the alternative, the raised region 154 may increase the impacting of the fines 31 and the slag 29 with side walls of the raised region 154. Moreover, the raised region 154 may increase mixing of the fines 31 and the slag 29 with the feed 20, and/or expansion of the produced syngas 24, fines 31, and slag 29. Accordingly, the raised region 154 may further promote carbon conversion of the feed 20. In the illustrated embodiment, the produced syngas 24, fines 31, and slag 29 may exit the first gasification reaction zone 28 through the second conduit 44 (e.g., via the reaction zone outlet 30). In some embodiments, the capped portion 152 may include an opening on a top wall 156 of the capped portion 152 such that the produced syngas 24, fines 31, and slag 29 may exit the first gasification reaction zone 28 via the opening, in addition to the reaction zone outlet 30.

The tenth reaction fixture 160, as illustrated in FIG. 14, is also similar to the seventh reaction fixture 130, as illustrated in FIG. 11, except that the tenth reaction fixture 160 includes the impacting walls 166 disposed about the ends 45, 48 of the first conduit 42. Additionally, the tenth reaction fixture 160 is disposed in the open top gasifier 162 that may be used in a gasification or IGCC system where the gasifier 162 is directly coupled to a downstream system, such as a syngas cooler, secondary reactor, or partial quench. The impacting walls 166 may be aligned with the side wall 110 of the gasifier 162 such that the first gasification reaction zone 28, defined at least by the first wall 26, the second wall 32, and the impacting walls 166, is substantially within the gasifier 162. The impacting walls 166 may provide additional area, besides the first wall 26 and the second wall 32, for the produced fines 31 and slag 29 to impact within the first gasification reaction zone 28, thereby increasing the carbon conversion of the feed 20. The impacting walls 166 may be manufactured with any material, such as refractory material, suitable for the interior wall 39 of the gasifier 162. The impacting walls 166 may include one or more openings configured to pass the injected feed 20 from the injectors 22, 122 to the first gasification reaction zone 28. In some embodiments, the reaction fixture may include one impacting wall 166 about either end 45, 48 of the first conduit 42.

As illustrated, the tenth reaction fixture 160 is disposed within the open top gasifier 162. However, it should be noted that the tenth reaction fixture 160 may be similarly disposed within any suitable gasifier 10, such as those illustrated in FIGS. 11-13. Likewise, the reaction fixtures 130, 140, 150 may be similarly disposed within the open top gasifier 162. In addition, it should be noted that the reaction fixtures 130, 140, 150, 160 that include two feed injectors 22, 122 may also be disposed on top of the gasifier 10, for example, onto the top port 108 as illustrated in FIG. 8. Furthermore, it should be noted that the gasifier 10 may include any combination of the embodiments of the reaction fixture 11 (e.g., the reaction fixtures 40, 70, 90, 100, 120, 130, 140, 150, 160), in accordance with the present disclosure.

This written description uses examples to disclose the embodiments, including the best mode, and also to enable any person skilled in the art to practice the present disclosure, including making and using any devices or systems and performing any incorporated methods. The patentable scope of the present disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a gasifier configured to gasify a feed to generate syngas, wherein the gasifier comprises a first axis;
a first gasification reaction zone disposed in the gasifier, wherein the first gasification reaction zone is defined at least partially by a first wall substantially perpendicular to the first axis; and
a first feed injector coupled to the gasifier, wherein the first feed injector is configured to inject the feed into the first gasification reaction zone beneath the first wall in a first direction relative to the first axis.

2. The system of claim 1, wherein the first wall is concave and is configured to direct the syngas in the first direction.

3. The system of claim 1, comprising a reaction zone outlet disposed in a second wall disposed opposite from the first wall, wherein the reaction zone outlet is configured to direct the syngas in the first direction substantially parallel to the first axis.

4. The system of claim 1, wherein the gasifier comprises a gasifier outlet configured to convey the syngas from the gasifier in a second direction substantially opposite from the first direction substantially parallel to the first axis.

5. The system of claim 1, comprising a second feed injector coupled to the gasifier, wherein the second feed injector is disposed substantially opposite from the first feed injector.

6. The system of claim 1, wherein the first wall comprises a mixing chamber configured to increase at least one of mixing, or expansion, or both, of at least one of the feed, the syngas, or both.

7. The system of claim 1, wherein the second wall is sloped toward the reaction zone outlet to enable slag produced during gasification to flow toward the reaction zone outlet.

8. The system of claim 1, comprising an outlet conduit coupled to the reaction zone outlet, wherein the outlet conduit is configured to direct the syngas in the first direction.

9. A method, comprising:
gasifying a feed in a gasification reaction zone disposed in a gasifier to generate syngas, wherein the gasifier comprises a first axis;
injecting the feed into the gasification reaction zone using a feed injector coupled to the gasifier;
flowing the syngas through the gasification reaction zone in a first direction substantially perpendicular to the first axis using a first wall; and
discharging the syngas from the gasification reaction zone in a second direction substantially parallel to the first axis.

10. The method of claim 9, wherein discharging the syngas from the gasification reaction zone comprises discharging the syngas through a first reaction zone outlet disposed in a second wall disposed opposite from the first wall.

11. The method of claim 9, comprising receiving the syngas generated in the gasification reaction zone in at least one of a quench chamber, a partial quencher, a syngas cooler, or a reactor, or any combination thereof.

12. The method of claim 9, comprising flowing the syngas through the gasification reaction zone in a third direction substantially opposite from the first direction using a third wall substantially parallel to the first axis.

13. The method of claim 9, comprising discharging a portion of the syngas from the gasification reaction zone in a fourth direction substantially opposite from the second direction through a second reaction zone outlet.

14. A system, comprising:
a gasifier configured to gasify a feed to generate syngas, wherein the gasifier comprises a first axis;
a gasification reaction zone disposed in the gasifier, wherein the gasification reaction zone is defined by a first conduit with a second axis substantially perpendicular to the first axis;
a first outlet disposed in the first conduit, wherein the first outlet is substantially centered about the first axis and is configured to direct the syngas in a first direction substantially parallel to the first axis; and
a first feed injector coupled to a first end of the first conduit, wherein the first feed injector is configured to inject the feed into the gasification reaction zone in a second direction substantially perpendicular to the first axis.

15. The system of claim 14, comprising a second feed injector coupled to a second end of the first conduit, wherein the second feed injector is configured to inject the feed into the gasification reaction zone in a third direction substantially opposite from the second direction.

16. The system of claim 14, wherein the first conduit comprises a channel configured to direct slag produced during gasification toward the first outlet.

17. The system of claim 14, wherein the gasifier comprises a top outlet configured to receive at least a portion of the syngas from a fourth direction substantially opposite from the first direction.

18. The system of claim 14, comprising a second conduit at least partially surrounding the first conduit.

19. The system of claim 18, comprising a second outlet disposed in the second conduit, wherein the second outlet is configured to direct a portion of the syngas in a fourth direction substantially opposite from the first direction.

20. The system of claim 14, comprising an outlet conduit coupled to the first outlet, wherein the outlet conduit is configured to direct the syngas in the first direction.
